(19) United States
(12) Patent Application Publication
(10) Pub. No.: US 2012/0178315 A1
(43) Pub. Date: Jul. 12, 2012

(54) PLUG CONNECTOR FOR A BLADE CONTACT

(75) Inventors: Bernhard Knüttel, Bad Neustadt (DE); Annegret Suckfüll, Mittelstreu (DE); Verena Zimmerman, Niederlauer (DE)

(73) Assignee: PREH GMBH, Bad Neustadt a. d. Saale (DE)

(21) Appl. No.: 13/140,214

(22) PCT Filed: Dec. 14, 2009
(86) PCT No.: PCT/EP2009/067053

§ 371 Date: Sep. 7, 2011

(30) Foreign Application Priority Data
Dec. 16, 2008 (DE) 10 2008 062 578.7

(51) Int. Cl. H01R 13/11; H01R 43/16

(52) U.S. Cl. 439/850; 29/885

(57) ABSTRACT

The invention relates to a punched grid with a blade receiving contact including at least two symmetrical contact springs forming a blade receiving contact and extending from a base area, the contact springs being spaced from each other so that a gap is formed and the contact springs have at their free ends a curved portion narrowing the gap, wherein an embossed contour is formed into at least one curved portion of a contact spring, the invention further relating to a method for producing a blade receiving contact.

### TECHNICAL FIELD

The invention relates to a blade receiving contact comprised of at least two symmetrical contact springs extending from a base area, the contact springs being spaced from each other so that a gap is formed and the contact springs have at their free ends a curved portion narrowing the gap. Further, the invention relates to a method for producing a blade receiving contact.

### BACKGROUND

Punched grids are known for central electrical systems of motor vehicles; reference is made to DE 197 13 008 C1 by way of example. In order to form blade contacts as connection contacts, ends of web conductors of the punched grid are bent so as to protrude perpendicularly from the punched grid. In order to form blade receiving contacts as connection contacts, a gap is punched, when the punched grid is punched, into the respective ends of the web conductors before they are bent so as to protrude perpendicularly. In order to form the blade receiving contacts, the ends of the web conductor can be broadened. The blade contacts and blade receiving contacts serve for electrically connecting fuses, relays and other electrical and electronic components that comprise a blade receiving contact or a blade contact. The contacts of the components are plugged into or onto the connection contacts of the punched grid.

Another punched grid onto whose web conductor blade contacts are plugged as connection contacts is known from DE 39 28 751 A1. The blade contacts comprise two mutually parallel tabs for plugging which form a gap between them with which the connection contacts are plugged onto a web conductor of the punched grid. In order to mechanically fix the connection contacts, they are plugged in an electrically insulating lid which forms a socket for the connection contacts and retains them mechanically.

A punched grid with a connection contact that is a part which was originally separate from the punched grid and is connected with the punched grid is described in OE 101 49 547 C2. In this case, the connection contact is a blade receiving contact comprising two contact springs integrally connected with each other in the base area, each contact spring being connected, while forming a lever arm, with the punched grid at a distance from the free end of the contact springs and at the base area. When the blade receiving contact is plugged onto the punched grid, the ends of the processes are pushed apart and the contact springs are compressed through the processes, and the gap between the contact springs is narrowed. It is thus possible to adapt the gap of the blade receiving contact producing the contact force to the material thickness of a blade contact to be plugged into the gap while maintaining the gap in the punching tool.

### BRIEF SUMMARY

The invention provides a punched grid with a blade receiving contact which, on the one hand, makes it possible to simplify surface finishing and, on the other hand, serves for increasing contact stability.

In the punched grid according to the invention with at least one blade receiving contact provides an embossed contour being formed into at least one curved portion of a contact spring. Due to the inventive configuration of the contact spring, the possibility of producing a contact strip having a gap width between the contact springs of greater than 0.3 mm is provided. This offers the advantage that a reliable and uniform surface finishing can take place on the contact springs. According to the invention, the embossed contour is put into the contact springs after surface finishing so that the gap width between the contact springs is adjustable between almost 0 and 0.2 mm. In the process, the embossed contour is placed in an area of the contact springs that enables the gap to be reduced. Preferably, the embossed contour is put into the curved portions of the contact springs forming the gap. In this case, the embossed contour follows the shape of the curved portions of the contact spring at a distance from the gap.

By embossing an embossed contour at a distance from the gap and along the curved portion, the contact spring(s) is/are deformed and stretched in such a manner that the gap width can be varied depending on the embossing used. Due to the adjustable gap width, a higher force can be applied to the blade or blade strip, which in the end serves for increasing contact stability between the blade receiving contact and the blade or the web strip or the conductor web.

It is another considerable advantage of the invention that, prior to the embossed contour being put into it, the gap width can be adjusted to be so large that a reliable and uniform surface finishing on the contact springs, and in particular in the area of the gap between the curved portions of the contact springs, can be achieved. The surface finishing is not destroyed in the subsequent embossing process.

The blade receiving contact with the embossed contour according to the invention preferably is a contact strip, the contact strip being produced by means of punching. Once the blade receiving contacts have been punched out, the punched contact strip is surface-finished. After finishing, the embossing process, and thus the adjustment of the gap width, takes place. Finally, the blade receiving contacts are preferably bent out of the contact strip perpendicularly so that a blade contact, a web strip and/or a conductor strip can be contacted.

Moreover, the invention relates to a method for producing a blade receiving contact comprising at least the following method steps:
punching a connection contact with symmetrical contact springs, wherein the punching process is carried out in such a way that a gap is produced between the contact springs,
finishing, in particular surface coating of the blade receiving contact, and
embossing an embossed contour into at least one contact spring so that the gap between the contact springs is reduced.

By means of the method according to the invention, the possibility is now provided to reliably finish the area between the curved portions of the contact springs. One problem that arises in connection with blade receiving contacts is that, on the one hand, as small a gap as possible must be provided in order to ensure a reliable contact with the blade contact, and on the other hand, to produce a uniform coating free from defects in the area of the gap between the opposing contact springs. On the one hand, a small gap width is necessary given the low thickness of the blade contacts, which is most frequently less than 1 mm, on the other hand, the surface finishing requires a gap width of a minimum of about 0.3 mm in order to ensure a surface finishing free from defects. By means of the method according to the invention of embossing a contour into the contact springs, a method is provided which makes it possible to produce a minimal gap between the contact springs.

For the method according to the invention, contact strips are punched out from a conductive metal sheet which can also be referred to as punched grids. After the contact strip has been punched out, a surface finishing process is carried out with a material that improves the contact or is conductive, such as, for example, nickel or copper or alloys thereof. Since surface finishing is most frequently carried out in a wet-chemical manner, gap widths are required therefor which make it possible that, on the one hand, the chemical substances reach all areas of the contact strip and, on the other hand, that there is a distance between the parts of the contact strip sufficient for ensuring a reliable deposition of the materials on the surface of the contact strip. A distance can in this case be specified to have a size of about 0.3 mm.

### BRIEF DESCRIPTION OF THE DRAWINGS

The invention is explained below in more detail with reference to an exemplary embodiment. In the drawings:

FIG. 1 shows the top view onto a contact strip after punching and surface finishing, and

FIG. 2 shows a detailed view of a blade receiving contact provided bent out from the contact strip.

### DETAILED DESCRIPTION

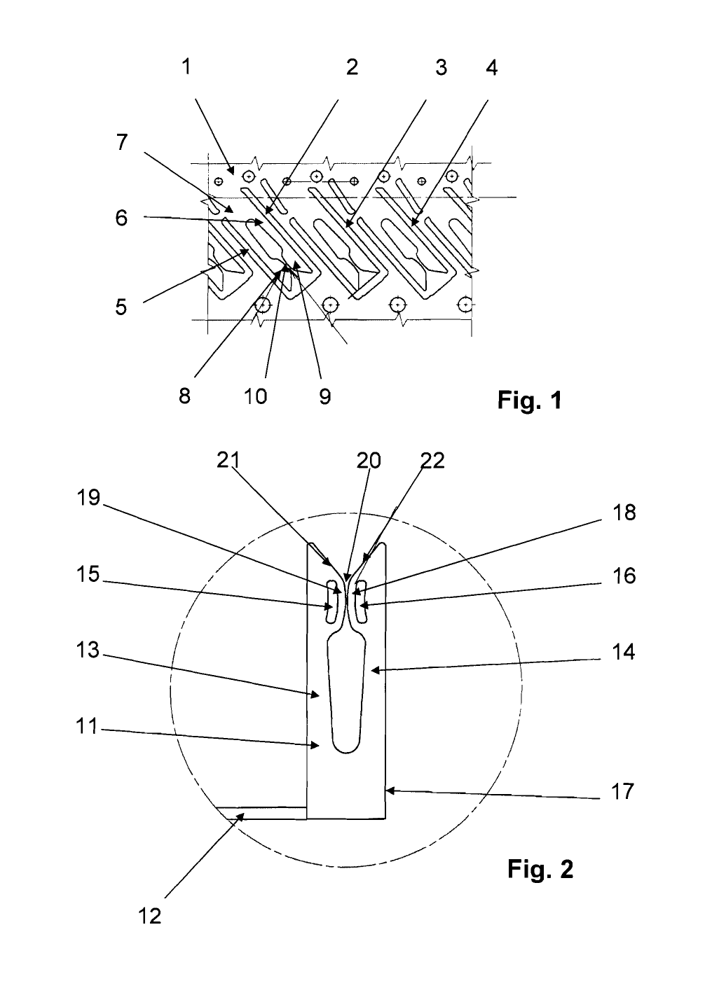

In FIG. 1, a contact strip 1a with punched-out blade receiving contacts 2, 3, 4 is presented in a top view. This is a customary contact strip 1 used in the automobile industry, which contacts, for example, the blade contacts of an engine of a throttle body.

The blade receiving contact 2, 3, 4 is formed of two contact springs 5, 6; in this case, only the contact springs 5, 6 of the blade receiving contact 2 were provided with reference numerals for the sake of clarity. The contact springs 5, 6 extend out from the contact strip 1 from a base area 7 into an area formed of two curved portions 8, 9 extending towards each other. A gap 10 is punched out between the curved portions 8, 9 of the contact springs 5, 6.

After punching, the gap 10 has a width of greater than 0.3 mm and can thus be subjected to surface finishing very well. Nickel or copper or alloys thereof can be used as surface finishings. A reliable surface finishing is possible only due to the large gap width of greater than 0.3 mm.

The thickness of a blade contact is most frequently less than 1 mm. In order to obtain a resilient contacting of the blade receiving contact with the blade, the contacting gap 10 has to be very small. A very small distance 10 is difficult to produce and cannot be reliably surface-finished any more from a width of about 0.3 mm. According to the invention, the gap width 10 is adjustable even after the punching and surface finishing processes. In other words, the invention presents a possibility with which the gap width 10 can be minimized and can have an optimum surface finishing at the same time.

In FIG. 2, a blade receiving contact 11 is shown enlarged and edged out from the contact strip 12. The blade receiving contact is edged out from the contact strip 12 perpendicularly and is surface-finished. Furthermore, the contact springs 13, 14 have embossed portions 15, 16.

In this case, the blade receiving contact 11 is comprised of a base area 17 starting at which the contact springs 13, 14 extend from the contact strip 12. In the process, the contact springs 13, 14 taper up to an area in which curved portions 18, 19 are formed onto the contact springs 13, 14. A gap 20 is formed between the curved portions 18, 19. The embossed portions 15, 16 extend in the area of the curved portions 18, 19 and along the gap 20, which makes the gap 20 adjustable.

The embossed portions 15, 16 can be put into the contact springs 13, 14 on one or both sides. The exemplary embodiment shown in FIG. 2 merely shows an alternative embodiment. In this case, it is also conceivable to put the embossed portions into the tapered area of the contact springs 13, 14 so long as the embossed portion is such that the gap 20 is narrowed thereby. The material of the contact strip 12 is deformed and stretched by the embossed portions in such a way that the gap can be minimized and adjusted up to the point where the curved portions 18, 19 meet. Thus, the gap width 20 can be adjusted to almost 0 mm so that the curved portions 18, 19 rest against each other. In order for the blade to be contactable to the blade receiving contact 11, or the contact 11 to be connectable to the blade, the contact springs 13, 14 comprise entry chamfers 21, 22 that enable easy plugging. The contact strip 1, 12 and the blade receiving contact 2, 3, 4, 12 have a thickness of about 1 mm, preferably less than 1 mm.

1. Punched grid with a blade receiving contact comprising:
at least two symmetrical contact springs forming a blade receiving contact and extending from a base area, the contact springs being spaced from each other so that a gap is formed and the contact springs have at their free ends a curved portion narrowing the gap,
wherein an embossed contour is formed into at least one of the contact springs into the curved portion.

2. Punched grid according to claim 1, wherein the blade receiving contact is part of a punched contact strip of an electrical connecting assembly.

3. Punched grid according to claim 1, wherein the blade receiving contact has a thickness of less than 1 mm.

4. Punched grid according to claim 1, wherein the punched grid is finished comprising nickel-plated or copper-plated.

5. Punched grid according to claim 1, wherein the gap has a width of about 0 mm to 0.2 mm.

6. Punched grid according to claim 1, wherein the curved portions rest against each other.

7. Punched grid according to claim 1, wherein several blade receiving contacts are formed on the punched grid.

8. Punched grid according to claim 1, wherein the embossed contour extends at a distance from the gap and along the curved portion.

9. Punched grid according to claim 1, wherein the embossed contour is an elongated depression in the contact spring.

10. Method for producing a blade receiving contact comprising:
punching a blade receiving contact with symmetrical contact springs, wherein the punching process is carried out in such a way that a gap is produced between the contact springs,
surface coating of the blade receiving contact, and
embossing an embossed contour into at least one contact spring so that the gap between the contact springs is reduced.

11. Method for producing a blade receiving contact according to claim 10, wherein, by means of the embossing process, the gap width is reduced from about 0.3 mm to a gap width of less than 0.3 mm.

12. Method for producing a blade receiving contact according to claim 10, wherein, by means of the embossing process, the gap width is reduced to about 0 to 0.2 mm.

13. Method for producing a blade receiving contact according to claim 10, wherein, by means of the embossing process, the contact springs are reduced in such a way that the contact springs are deformed in such a way that the contact springs rest against each other in an area of the curved portion.

14. Method for producing a blade receiving contact according to claim 10, wherein the embossed contour is put into the contact spring with a distance from the gap.

15. Blade receiving contact produced in accordance with the method according to claim 10.
